(19) United States
(12) Patent Application Publication
(10) Pub. No.: US 2003/0011474 A1
(43) Pub. Date: Jan. 16, 2003

(54) Circuit and method for electronic security seal

(76) Inventor: Sing King Ng, Le Shantier (SG)

Correspondence Address: KIRKPATRICK & LOCKHART LLP, 535 SMITHFIELD STREET, PITTSBURGH, PA, 15222, US

(21) Appl. No.: 09/904,743

(22) Filed: Jul. 13, 2001

(51) Int. Cl. G08B 13/14

(52) U.S. Cl. 340/568.1; 340/572.8

(57) ABSTRACT

Disclosed is an electronic circuit for an electronic seal of an identification system, wherein the seal is for communicating with a reader of the identification system, the seal including a bolt, the bolt including a shank and a housing that defines a cavity for receiving the shank. The electronic circuit includes: a controller having an input channel for receiving a first signal indicative of a status of the shank, and for generating a second signal based on the first signal; and a transmitter in communication with the controller for transmitting the second signal to the reader.

### BACKGROUND

1. Technical Field

This invention relates generally to telemetric data communication systems such as radio frequency identification (“RFID”) systems.

2. Description of Related Art

In the shipping industry, containers are widely employed. Such containers typically have doors, which are locked shut with hasps and secured with locking seals. Such seals include bolt seals, each of which comprises a seal body and a steel bolt having a head and shank. When the shank is inserted into the body, a locking mechanism permanently locks the shank to the body. This kind of seal is a conventional mechanical seal and no circuitry or electronic components are involved. Manual seals, however, may be tampered with and/or replaced without detection. Discovery of such a tampering and/or replacement is often too late for anyone to determine at which point the tampering occurred. Backtracking by the consignee is in fact impossible as the consignee would have to cut the seal before discovering the cargo had been tampered.

Accordingly, there is a need in the shipping industry for a more intelligent device. There is also a need for a security seal for facilitating a 100% verification of security seals, improving accuracy, enhancing security, simplifying investigations, expediting checking containers and determining container clearances. Further, there is a need for a security seal comprising a circuit that is programmable and can transmit information programmed in its memory, such as identification numbers, data associated with the security seal such as data indicative of an identification number of the security seal, data associated with a shipment such as destination of the shipment, consignee, load port, discharge port and vessel number, data associated with a container and the like. There is also a need for a security seal comprising RFID technology, such as an RFID tag, for example.

### SUMMARY

According to one embodiment, the present invention is directed to an electronic circuit for an electronic seal. One aspect of the invention provides an electronic circuit for an electronic seal of an identification system, wherein the seal is for communicating with a reader of the identification system, the seal including a bolt, the bolt including a shank and a housing that defines a cavity for receiving the shank. The electronic circuit includes: a controller having an input channel for receiving a first signal indicative of a status of the shank, and for generating a second signal based on the first signal; and a transmitter in communication with the controller for transmitting the second signal to the reader.

In one embodiment, the invention provides a circuit wherein the status of the shank is selected from the group consisting of a locked state and a tampered state. In another embodiment, the invention provides a circuit wherein the second signal includes a data frame, wherein the data frame includes a preamble, at least one data block, and at least one synchronization block, wherein the data block includes data indicative of the status of the shank. Further in one embodiment, the invention provides a circuit wherein the data frame includes three identical data blocks and a synchronization block between each data block, and the controller is for pseudo-randomly generating the data frame of the second signal, such that the data frame may be pseudo-randomly transmitted by the transmitter to the reader. According to another embodiment, the data block may include data associated with the seal. Also, the data block may include data indicative of an identification number of the seal. The data block also may include data associated with a shipment. The shipment data may also include data associated with the shipment that is selected from the group consisting of destination, consignee, load port, discharge port and vessel number. In one embodiment, the data block includes data associated with a container.

In yet another embodiment, the invention provides a circuit that includes a power supply for powering both the controller and the transmitter. In addition, the circuit may further include an antenna in communication with the transmitter.

In still another embodiment, the invention provides a circuit that includes a memory in communication with the controller, wherein the memory stores a tamper code and a normal code, and wherein the controller is for generating the second signal using one of the tamper code and the normal code based on the status of the shank. The controller may also include: a security checking module in communication with the memory, wherein the security checking module is for receiving the first signal and generating the second signal based thereon; and a modulation circuit in communication with the security checking module and the transmitter for encoding the signal second prior to transmission by the transmitter. In a further embodiment, the invention provides a circuit that includes a modulation circuit for FSK encoding the second signal. In addition, the controller may also include a random generator module in communication with modulation circuit, and a clock generator module in communication with the random generator module. In one embodiment, the invention further provides a circuit wherein the controller includes a start-up checking module for generating the second signal upon insertion of the bolt into the housing.

Another aspect of the invention provides a method of monitoring an electronic seal of an identification system, wherein the seal is for communicating with a reader of the identification system, the seal including a bolt, the bolt including a shank and a housing that defines a cavity for receiving the shank. The method includes receiving a first signal indicative of a status of the shank, generating a second signal based on the first signal, and transmitting the second signal to the reader.

In one embodiment, the invention provides a method wherein generating the second signal includes generating a data frame, wherein the data frame includes a preamble and at least one data block, wherein the data block includes data indicative of the status of the shank. In another embodiment, the invention provides a method wherein the transmitting the second signal to the reader includes pseudo-randomly transmitting the data frame to the reader. In one embodiment, the invention further provides a method wherein the data frame includes three identical data blocks and a synchronization block between each data block. Also, in another embodiment, the invention further provides a method wherein the data frame includes data associated with the seal. The data associated with the seal may also include data indicative of an identification number of the seal. In another embodiment the data frame may also include data associated with a shipment. The data associated with the shipment includes data selected from the group consisting of destination, consignee, load port, discharge port and vessel number. In one embodiment, the data frame may also include data associated with a container.

These and other aspects of the present invention will be apparent from the detailed description hereinafter.

### BRIEF DESCRIPTION OF THE DRAWINGS

The present invention will be described in conjunction with the following figures, wherein:

FIG. 1 illustrates one embodiment of an RFID system that can be used in conjunction with an electronic circuit for a seal communication system according to the present invention;

FIG. 2 illustrates one embodiment of a front elevation of an electronic seal having an electronic circuit according to the present invention;

FIG. 3 illustrates one embodiment of a plan view of a portion of a printed circuit board assembly layout of an electronic circuit for a seal according to the present invention;

FIG. 3A illustrates one embodiment of a side elevation view of a printed circuit board illustrated in FIG. 3;

FIG. 4 illustrates one embodiment of a block diagram of an electronic circuit for a seal according to the present invention;

FIG. 5 illustrates one embodiment of a schematic block diagram of an electronic circuit and fragmented sectional side elevation view of a bolt according to the present invention;

FIG. 5A illustrates one embodiment of a system diagram according to the present invention;

FIG. 6 illustrates one embodiment of a side elevation sectional view of a bolt for use with an electronic circuit according to the present invention;

FIG. 7 illustrates one embodiment of a data frame of an electronic circuit for a seal according to the present invention;

FIG. 8 illustrates one embodiment of a data encoding method according to the present invention;

FIG. 9 illustrates one embodiment of a timing diagram illustrating a pseudo-random timing of a transmission according to the present invention; and

FIGS. 10A-B illustrate one embodiment of a method of sealing a container using an electronic circuit according to the present invention.

### DETAILED DESCRIPTION

It is to be understood that the figures and descriptions of the present invention have been simplified to illustrate elements that are relevant for a clear understanding of the present invention, while eliminating, for purposes of clarity, other elements of conventional nature.

RFID tags can be divided into two broad categories: passive and active. A passive RFID tag is generally powered by energy coupled via magnetic induction and an active RFID tag is powered by a power source, such as a battery, for example. An RFID tag generally includes a radio frequency (“RF”) transmitter, an RF receiver, an RF modulator and a memory. The memory can store desired data, such as the RFID tag number and other information. The RF modulator extracts the data from the memory and provides modulated signals to transmitter. The RF receiver receives signals from the RFID tag and relays the signals received. In one embodiment, an electronic seal comprises an active RFID tag powered by battery.

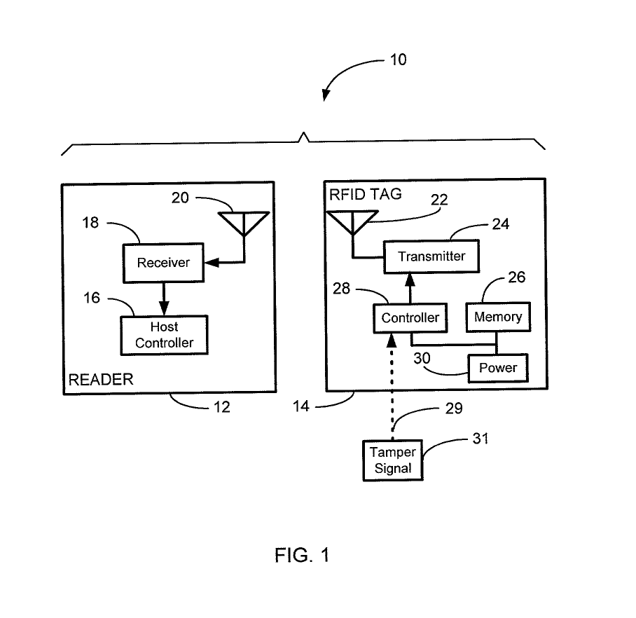

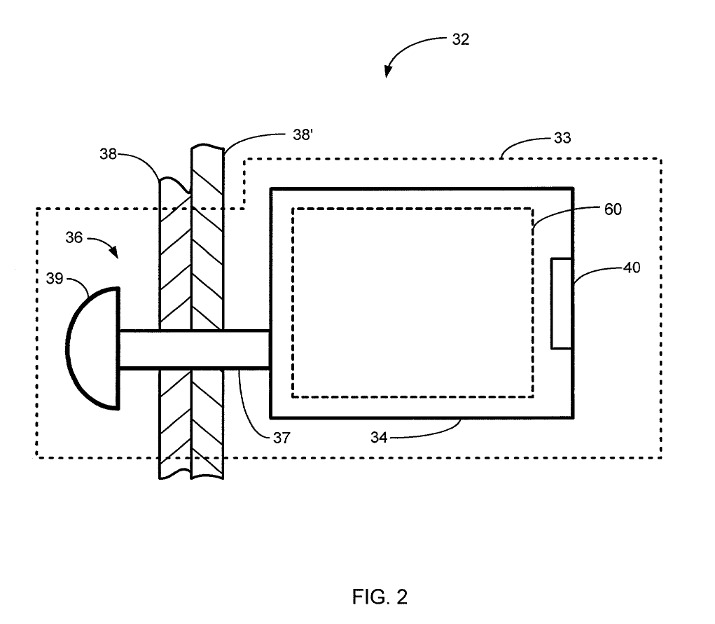

FIG. 1 illustrates one embodiment of an RFID system 10 for an electronic seal identification system utilizing an RFID tag. The RFID system 10 includes generally a reader 12 and an RFID tag 14 that can be applied to an electronic circuit 60 for a seal in accordance with the present invention (See FIGS. 2, 4, 5 and 5A). The reader 12 may include a host controller 16 for processing signal information from the RFID tag 14 and a receiver 18 for receiving a signal from an antenna 20 indicating the RFID information from the RFID tag 14. Further, the RFID tag 14 may include an electronic circuit 60 comprising an antenna 22, a transmitter 24, a memory 26, a controller 28 and a power supply 30. The controller 28 receives a tamper signal 31 from an electromechanical tamper detection device (not shown) via electrical conductor 29 that is connected to an input channel of the controller 28. The controller 28 receives the tamper signal 31 at the input, extracts certain information from the memory 26 based on the tamper signal and encodes the extracted information in a special pattern. The transmitter 24 then broadcasts the information through the antenna 22 to the reader 12. In one embodiment, the controller 28 can include other interfaces, not shown, for receiving signals from external transponders, such as pressure sensors, temperature sensors and tamper detectors, for example.

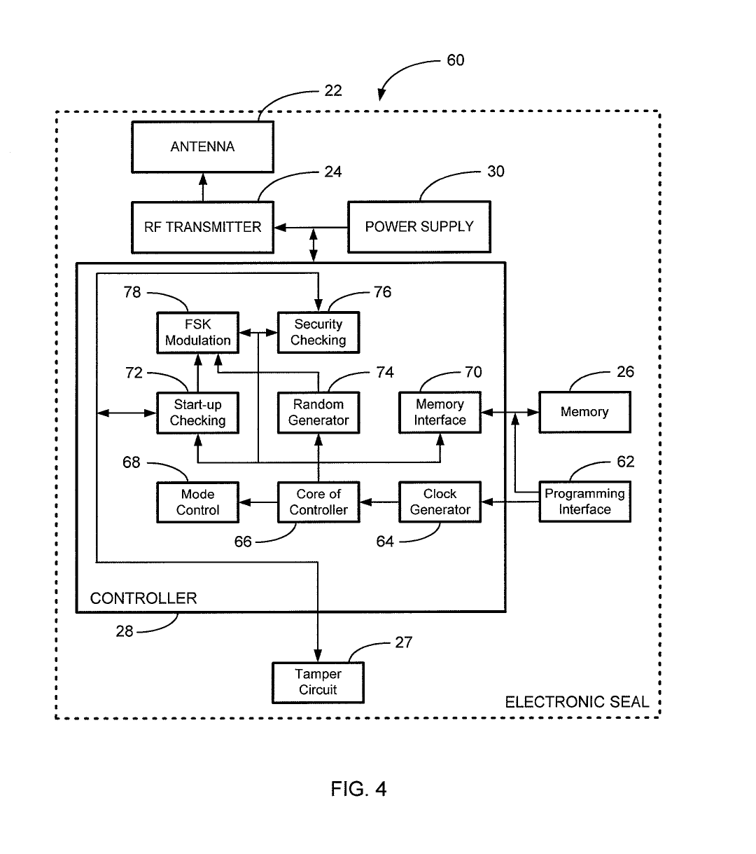

FIG. 2 illustrates one embodiment of an electronic seal 32 according to the present invention. The electronic seal 32 can include a steel bolt 36 and a body 33. The body 33 can be formed from molded thermoplastic, for example. The body 33 includes a housing 34 defining a cavity for receiving the bolt 36. In one embodiment, the bolt has an elongated shank 37 and a head 39. The electronic seal 32 may also have an electronic circuit 60 (See FIG. 4) embedded in the housing 34 of the seal 32. A signal generation source can be embedded within the electronic circuit 60 contained within the housing 34. The bolt 36 is received into the cavity and the shank 37 is locked to the cavity of the housing 34. In one embodiment, the bolt 36 is made to be electrically conductive such that the circuit between the bolt 36 and the electronic circuit 60 is completed. As a result, when the bolt 36 is inserted in the cavity, the power supply 30 is activated and energizes the electronic circuit 60 of the electronic seal 32. When the power is initially applied to the electronic circuit board 60, the transmitter 24 may transmit a first data signal code representative of the status of the bolt 36. Subsequently, the transmitter 24 may transmit a signal code associated with the status of the bolt 36 on a periodic pseudo-random basis. When a tamper condition occurs, for example when the shank 37 of the bolt 36 is severed, a “tamper” signal is provided to the controller 28. Accordingly, the controller 28 then generates a second data signal code that is associated with the tampered status of the shank 37. In one embodiment, however, the transmissions can occur continuously regardless of whether a tamper condition is present or has occurred.

In one embodiment of the invention, the electronic seal 32 includes the electronic seal housing 34 and the bolt 36. The bolt 36 locks hasps 38 and 38′ together. The hasps 38 and 38′ may be part of the doors of a cargo container, for example, for locking the container door shut. In one embodiment, the housing 34 may further include an opening 40 (“door” hereinafter) for programming an electronic seal identification number and a container number in the memory 26 of the electronic seal 32. Once the bolt 36 is inserted, the door 40 is closed, and no further programming is allowed. The door 40 acts as a physical receptacle and provides a connection for programming and downloading data such as, e.g., the electronic seal identification number and the container number data into the memory 26 provided on the circuit board. In another embodiment, the electronic circuit 60 includes contacts for receiving a programming unit for programming and downloading data into the memory chip 26 located on the electronic circuit 60. The programming unit can be, for example, either portable or a fixed cradle type.

In one embodiment, once the bolt 36 has been inserted into the housing 34 and locked in place, the door 40 closes and no further programming is permitted. Accordingly, once the bolt 36 has been inserted in the housing 34, a pair of retainer rings affixed to the circuit board, comprising the electronic circuit 60, are electrically connected to the circuit board and conduct electrical power from the power supply 30 to the electronic circuit 60. In another embodiment, the circuit board can include an electrical contact for engaging the received locked shank 37 and electrically coupling the electrical power supply 30 to the electronic circuit 60.

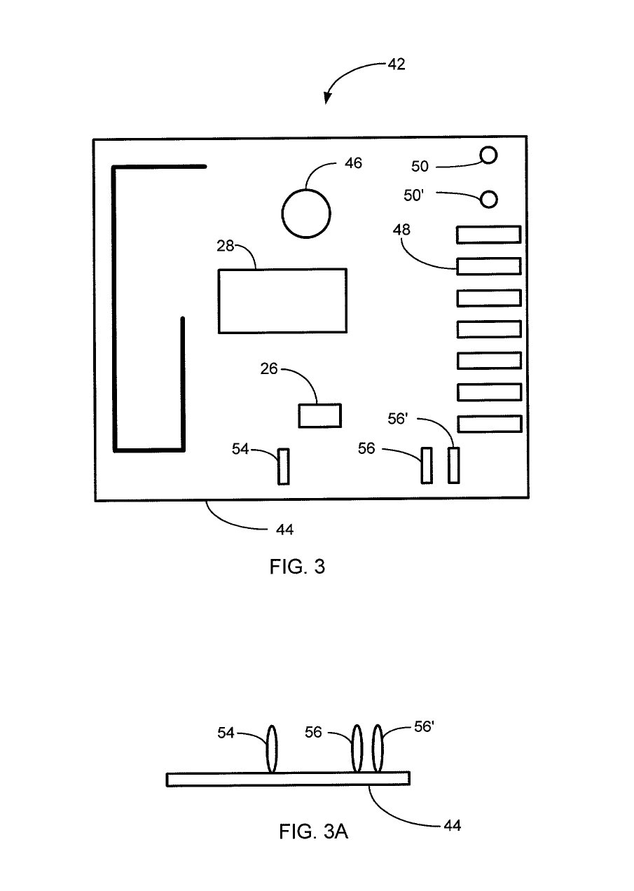

FIG. 3 illustrates one embodiment of a Printed Circuit Board Assembly 42 (“PCBA” hereinafter) comprising the electronic circuit 60 in accordance with the present invention. The PCBA 42 includes a circuit board 44 with a programmable circuit comprising the controller 28 and the memory 26. In addition, the PCBA 42 may also include other components such as, for example, crystals, capacitors, resistors, inductors, a SAW resonator 46 and/or transistors, for providing a programmable transmitting RFID tag circuit 14 similar to the circuit illustrated in FIG. 1. The circuit board 44 can include one or more electrical contacts 48 that provide an electrical path for programming the electronic seal 32, and can include contacts 50 and 50′ for providing a connection for the power supply 30 (e.g., a battery). Also included on the circuit board 44 are retainer rings 56 and 56′ for receiving the bolt 36 and completing or closing an electrical circuit path for detecting whether the electronic seal 32 has been tampered. In a further embodiment, an additional retainer ring 54 affixed to the circuit board 44. Accordingly, the bolt 36 and the retainer rings 54, 56, 56′ form a completed or closed electrical circuit path once the bolt 36 is inserted into the housing 34. When the bolt 36 is severed, for example, and the circuit path is broken or opened, a tamper signal 31 is sent to the controller 28 and is transmitted via the transmitter 24 and the antenna 22. As illustrated in FIG. 3A, in one embodiment the retainer rings 54, 56 and 56′ can be affixed to the circuit board 44 by directly soldering the rings 54, 56, 56′ thereto.

FIG. 4 illustrates one embodiment of a block diagram of the electronic circuit 60 provided on the circuit board 44. The electronic circuit 60 includes generally the controller 28, the memory 26 for storing information associated with the electronic seal 32, a programming interface 62 for providing means for programming (e.g., downloading) data into the electronic circuit 60, the RF transmitter 24 for transmitting signals through the antenna 22 and for providing general communications with the reader 12, and the power supply 30 for providing electrical power to the electronic circuit 60 for its operation.

The controller 28 further includes modules for performing one or more functions. The modules may be implemented, for example, as software code to be executed by the controller 28 using any suitable computer instruction type such as, for example, microcode, and may be stored in, for example, an electrically erasable programmable read only memory (EEPROM), or can be configured in the logic of the controller 28.

The controller 28 includes an input channel for detecting the presence of a signal such as a tamper signal 31. Further, in one embodiment the controller 28 may include a clock generator 64 to facilitate the synchronization and the operation of the controller 28. The controller 28 may also include a core of controller module 66 for running a task and a mode control module 68 for switching between different modes in order to reduce power consumption, for example. In one embodiment, the mode control module 68 may, for example, transition the mode of operation of the controller 28 between a sleep mode, a wake-up mode and a working mode. A power control module may be used to activate and deactivate the transmitter 24 for data transmission. The purpose of having different modes of operation is to reduce power consumption and prolong the life of the power supply 30.

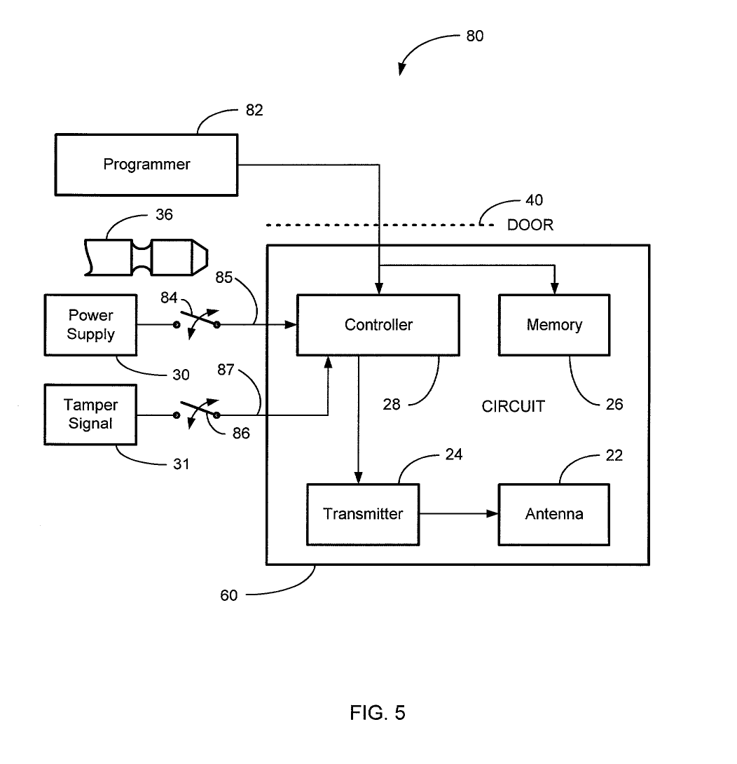

The controller 28 also includes a memory interface 70 that includes a facility for deciding when to release the memory bus for external programming and when to employ the bus for internal usage. The controller 28 further includes a start-up checking module 72 for checking whether the bolt 36 has been inserted and locked and, therefore, whether to transmit the first data frame. A random generator 74 may also be included in the controller 28 for determining when to transmit the next data frame. A security-checking module 76 may also be included in the controller 28 for monitoring whether the electronic seal 32 has been severed. The security-checking module 76 may receive the tamper signal received in the input channel of the controller 28. Based on the tamper signal, the security-checking module 76 generates the signal to be transmitted by the seal to the reader 12. According to one embodiment, the security-checking module 76 downloads a code from the memory 26 corresponding to the status of the shank 37, as discussed further herein in conjunction with FIG. 5A. The security-checking module 76 uses the downloaded code to generate the signal that is eventually transmitted to the reader 12.

In one embodiment, the data can be encoded in a FSK format before being sent to the transmitter 24 for transmitting. The data stream can generally include a preamble header followed by three identical repeated data blocks, for example. The data blocks may contain data indicative of the status of the shank 37. In one embodiment the data block may contain data associated with the seal 32 such as data indicative of an identification number of the seal 32, data associated with a shipment such as destination of the shipment, consignee, load port, discharge port and vessel number, data associated with a container and the like. Between each data block there also can be provided synchronization bits for improving the receiver's reliability, for example. Accordingly, the controller 28 may also include a FSK modulation module 78 for encoding the information to be sent to the transmitter 24 in a FSK format. According to one embodiment, the data may be transmitted regardless of whether the information indicated a normal or tampered condition.

In another embodiment, the electronic circuit 60 transmits a first frame of tamper signal data upon the interruption of the electrical power supply 30. Subsequently, the electronic circuit 60 according to the present invention also can transmit the data in a periodic pseudo-random manner. The pseudo-random interval is utilized for minimizing the probability of collision of transmissions from more than one electronic seal 32 in proximity to the reader 12.

FIG. 5 illustrates one embodiment of a schematic block diagram 80 including the electronic circuit 60 and a fragmented sectional side elevation view of the bolt 36. The schematic block diagram 80 also includes electromechanical interfaces that can be utilized with the electronic circuit 60 in accordance with one embodiment of the present invention. One of the electromechanical interfaces generally includes a programmer 82. In one embodiment, the electromechanical interface can include a portable hand-held device for programming the electronic seal 32 with an identification number, a container number and/or any other information, into the memory 26 of the electronic seal 32 via the door 40.

A fragmented sectional side elevation view of the bolt 36 is also shown in FIG. 5 that functionally may be represented schematically as two switches 84 and 86. When the bolt 36 is coupled to the electronic circuit 60, the first switch 84 closes, for example, and supplies electrical power to the electronic circuit 60 from the power supply 30 via conductor 85. When the bolt 36 is severed, the second switch 86 may open or close, for example, and the controller 28 detects the tamper signal 31 via conductor 87, as described previously. The tamper signal 31 is provided to one or more inputs that are generally provided in the controller 28.

FIG. 5A is a diagram of a system 90 utilizing the electronic circuit 60 in accordance with one embodiment of the present invention. The system 90 includes the reader 12 in communication with the electronic circuit 60, a logic block 92 for indicating that the bolt 36 is coupled to the electronic circuit 60, for example the bolt 36 is inserted in the retainer rings 54, 56, 56′, and a logic block 94 for indicating that the bolt 36 is in a tampered state. Moreover, in one embodiment, the memory 26 is further divided into two blocks referred to as a tamper code block 96 and a normal code block 98 for storing information relating to a tamper condition or a normal condition, respectively. The controller 28 utilizes the data in the tamper code block 96 and the normal block 98 for generating the signal that is transmitted to the reader 12, as discussed previously.

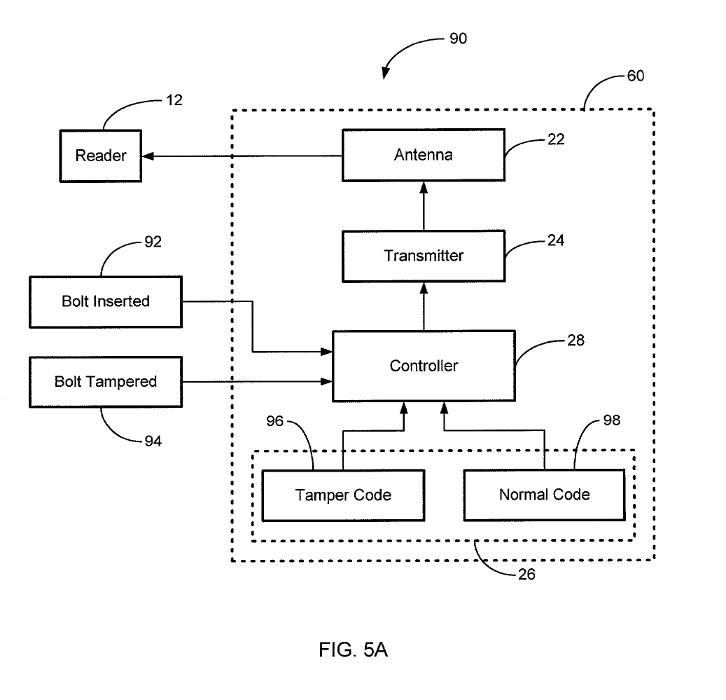

FIG. 6 illustrates is a side elevation view of the bolt 36 that can be utilized with one embodiment of the electronic circuit 60 according to the present invention. The bolt assembly 36 comprises a conductive exposed region 102 of the bolt shank 37 and a conductive head 110, an insulating coating 106, a conductive paint coating 108 and an insulating thermoplastic outer layer 112. The exposed region 102 of the bolt shank 37 for connects a pair of retainer rings 56 and 56′, for example, and thus completing the circuit. The bolt 36 also includes a locking groove 104 for locking the bolt 36 in place on the PCBA 42 or the seal housing 34 depending upon the desired implementation. The coating 106 is deposited over the most part of the bolt shank, from the locking groove 104 toward the head 110, excluding the bolt head surface 116 of bolt head 110.

The electrically conductive paint 108 is deposited over the insulating coating 106, exposing only a portion (a few millimeters) of the coating 106 from the locking groove 104. The coating 108 is deposited toward and over the entire of the bolt head 110 including the surface 116, making an electrically conductive contact with the exposed region 102 of the bolt shank 37, thus forming a tamper signal loop. The electrically conductive paint coating 108 is provided for making an electrical connection to the retainer rings 54, 56 and 56′ for detecting tamper events. The head 110 of the bolt 36 is coated with an electrically insulating thermoplastic layer 112 that includes a tapered region 114. The tapered region 114 allows the bolt 36 to be more easily inserted into the seal housing 34.

In one embodiment, the exposed bolt region 102 of the bolt shank 37 and coating 108 are ohmically connected via the surface 116 of the bolt head 110, thus forming a tamper signal loop. When the bolt 36 is severed, the controller 28 detects the open loop condition as a tamper condition and begins transmitting the appropriate information.

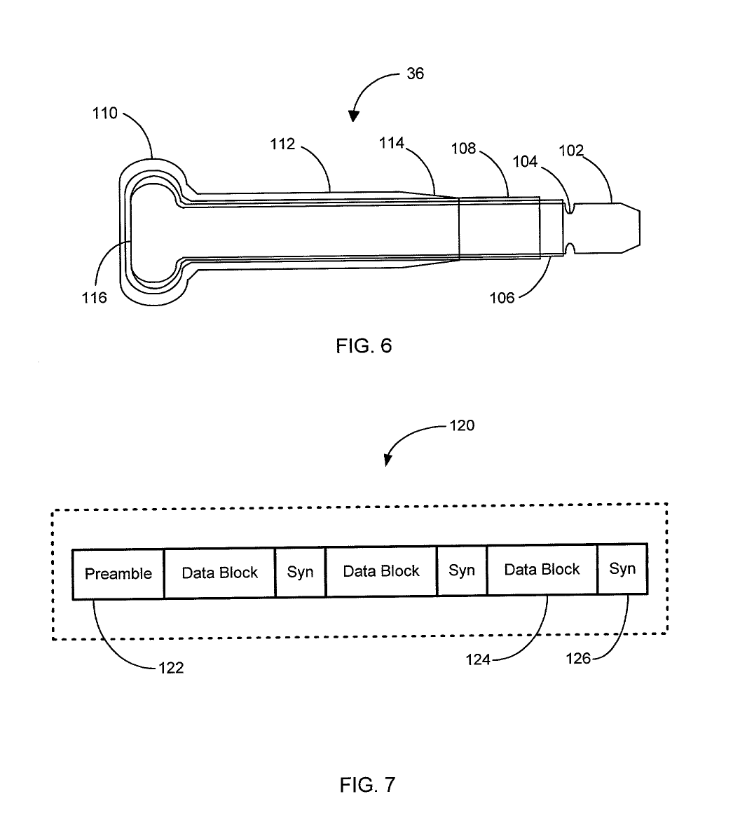

FIG. 7 illustrates a data frame 120 generated by the electronic circuit 60 in accordance with one embodiment of the present invention. The data frame 120 is the actual data frame code passed for modulation before being transmitted by the transmitter 24. The data frame 120 may also include a preamble 122 followed by three identical data blocks 124, with synchronization blocks (“SYN”) 126 between each data block 124. A SYN block 126 may also be provided at the end of the data frame 120. The data block 124 includes the data associated with the status of the shank 37. For example, the data block 124 includes the tamper code 96 or the normal code 98 indicative of whether the shank 37 is in a tampered state or a normal state, respectively.

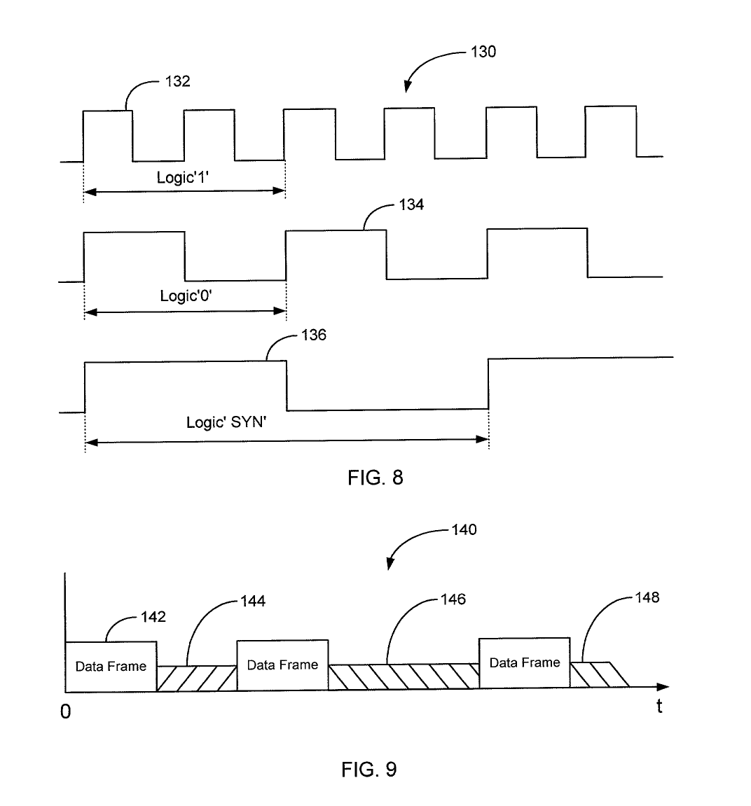

FIG. 8 illustrates generally at 130 one embodiment of a data encoding method according to the present invention. The data blocks 124, the preamble 122 and the SYN blocks 126 may be encoded in this manner. For example, waveform 132 is representative of a “Logic One,” waveform 134 is representative of a “Logic Zero,” and waveform 136 is representative of a SYN block 126. In one embodiment, the preamble 122 can include three SYN bits.

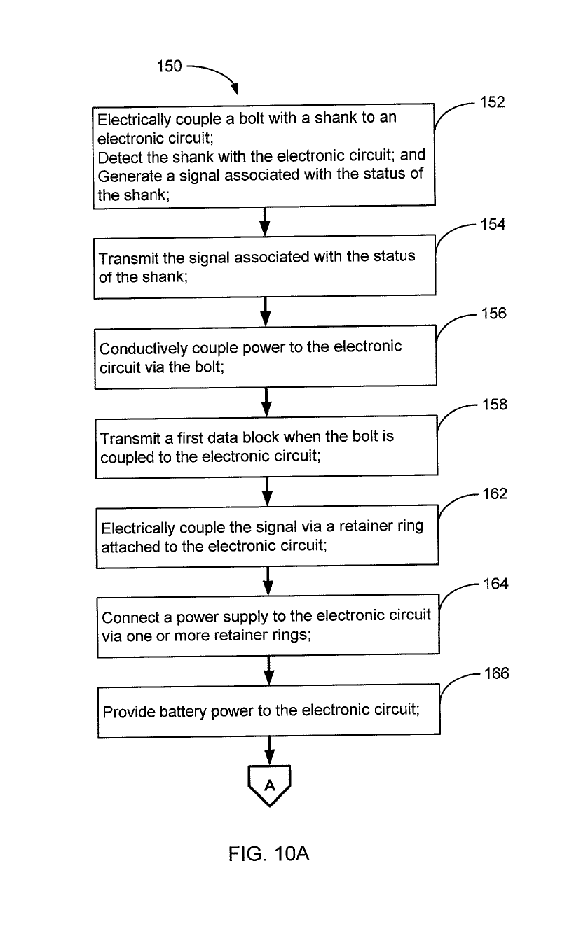

FIG. 9 illustrates generally at 140 one embodiment of a timing diagram illustrating a pseudo-random timing of a transmission pattern in accordance with the present invention. When multiple RFID tags 14 in the vicinity of one another broadcast simultaneously, the signals may collide and information may be garbled and lost as a result. In accordance with the present invention, the retransmission of signals in pseudo random manner can serve to minimize such collisions and ensure that the signal reaches the reader 12. Accordingly, once the bolt 36 is coupled to the electronic circuit 60, the power is applied to the electronic circuit 60, and thereby initiates a transmission of the first data frame 142. Subsequent data frames 142 will be transmitted pseudo-randomly. For example, the second transmission can occur after a time interval 144 and a third transmission can occur after a time interval 146, 148 and so on.

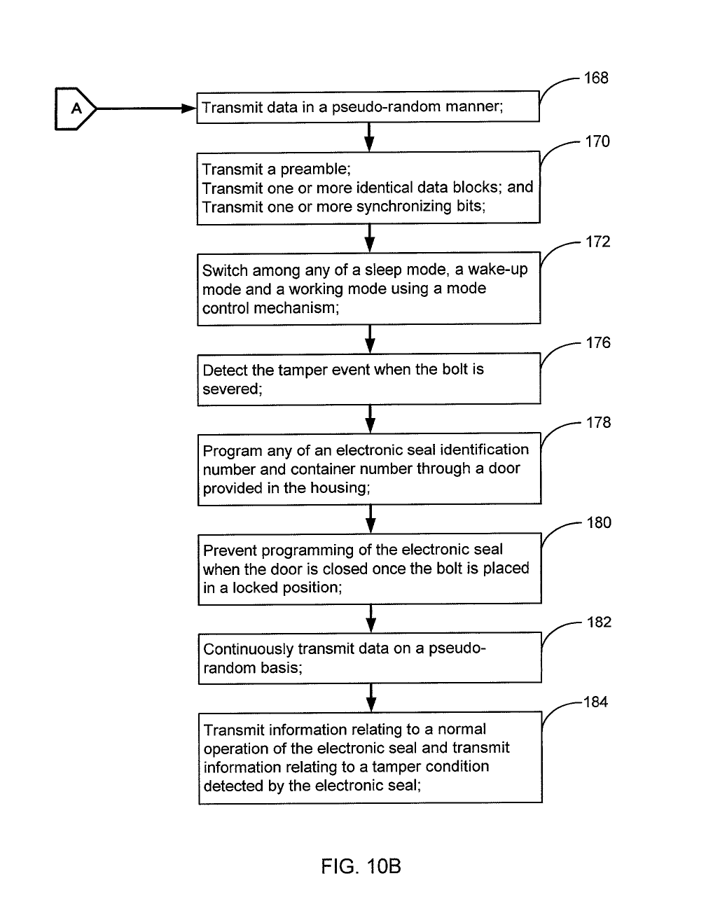

FIGS. 10A and 10B comprise a flow diagram of a method 150 according to one aspect of the invention. At block 152 the method includes electrically coupling a bolt with a shank to an electronic circuit, detecting the shank with the electronic circuit and generating a signal associated with the status of the shank. At block 154 the method includes transmitting the signal associated with the status of the shank. At block 156 the method includes conductively coupling power to the electronic circuit via the bolt. In one embodiment, at block 158 the method includes transmitting a first data block when the bolt is coupled to the electronic circuit. At block 162 the method includes electrically coupling the signal via a retainer ring attached to the electronic circuit and at block 164 the method includes connecting a power supply to the electronic circuit via one or more retainer rings. In one embodiment, at block 166 the method includes providing battery power to the electronic circuit.

Further in one embodiment, at block 168 the method includes transmitting data in a pseudo-random manner, and at block 170 the method includes transmitting a preamble, transmitting one or more identical data blocks and transmitting one or more synchronizing bits. At block 172 the method includes switching among any of a sleep mode, a wake-up mode and a working mode using a mode control mechanism. In one embodiment, at block 176 the method includes detecting the tamper event when the bolt is severed.

Further in one embodiment, at block 178 the method includes programming any of an electronic seal identification number and container number through a door provided in the housing and at block 180, the method includes preventing programming of the electronic seal when the door is closed once the bolt is placed in a locked position. At block 182, the method includes continuously transmitting data on a pseudo-random basis and at block 184, the method includes transmitting information relating to a normal operation of the electronic seal and transmitting information relating to a tamper condition detected by the electronic seal.

The foregoing description of the specific embodiments of the various embodiments of the invention has been presented for the purpose of illustration and description. It is not intended to be exhaustive or to limit the investigation to the precise form disclosed. Many modifications and variations are possible in light of the above teachings. It is intended that the scope of the invention be limited not with the description above but rather by the claims appended hereto.

What is claimed is:

1. An electronic circuit for an electronic seal of an identification system, wherein the seal is for communicating with a reader of the identification system, the seal including a bolt, the bolt including a shank and a housing that defines a cavity for receiving the shank, the electronic circuit comprising:
a controller having an input channel for receiving a first signal indicative of a status of the shank, and for generating a second signal based on the first signal; and
a transmitter in communication with the controller for transmitting the second signal to the reader.

2. The circuit of claim 1, wherein the status of the shank is selected from the group consisting of a locked state and a tampered state.

3. The circuit of claim 1, wherein the second signal includes a data frame, wherein the data frame includes a preamble, at least one data block, and at least one synchronization block, wherein the data block includes data indicative of the status of the shank.

4. The circuit of claim 3, wherein the data frame includes three identical data blocks and a synchronization block between each data block.

5. The circuit of claim 3, wherein the controller is for pseudo-randomly generating the data frame of the second signal, such that the data frame may be pseudo-randomly transmitted by the transmitter to the reader.

6. The circuit of claim 3, wherein the data block includes data associated with the seal.

7. The circuit of claim 6, wherein the data associated with the seal includes data indicative of an identification number of the seal.

8. The circuit of claim 3, wherein the data block includes data associated with a shipment.

9. The circuit of claim 8, wherein the data associated with the shipment is selected from the group consisting of destination, consignee, load port, discharge port and vessel number.

10. The circuit of claim 3, wherein the data block includes data associated with a container.

11. The circuit of claim 1, further comprising a power supply for powering both the controller and the transmitter.

12. The circuit of claim 11, further comprising an antenna in communication with the transmitter.

13. The circuit of claim 1, further comprising a memory in communication with the controller, wherein the memory stores a tamper code and a normal code, and wherein the controller is for generating the second signal using one of the tamper code and the normal code based on the status of the shank.

14. The circuit of claim 13, wherein the controller includes:
a security checking module in communication with the memory, wherein the security checking module is for receiving the first signal and generating the second signal based thereon; and
a modulation circuit in communication with the security checking module and the transmitter for encoding the signal second prior to transmission by the transmitter.

15. The circuit of claim 14, wherein the modulation circuit is for FSK encoding the second signal.

16. The circuit of claim 14, wherein the controller further includes a random generator module in communication with modulation circuit.

17. The circuit of claim 16, wherein the controller includes a clock generator module in communication with the random generator module.

18. The circuit of claim 14, wherein the controller includes a start-up checking module for generating the second signal upon insertion of the bolt into the housing.

19. A method of monitoring an electronic seal of an identification system, wherein the seal is for communicating with a reader of the identification system, the seal including a bolt, the bolt including a shank and a housing that defines a cavity for receiving the shank, the method comprising:
receiving a first signal indicative of a status of the shank;
generating a second signal based on the first signal; and
transmitting the second signal to the reader.

20. The method of claim 19, wherein generating the second signal includes generating a data frame, wherein the data frame includes a preamble and at least one data block, wherein the data block includes data indicative of the status of the shank.

21. The method of claim 20, wherein the transmitting the second signal to the reader includes pseudo-randomly transmitting the data frame to the reader.

22. The method of claim 20, wherein the data frame includes three identical data blocks and a synchronization block between each data block.

23. The method of claim 20, wherein the data frame includes data associated with the seal.

24. The circuit of claim 23, wherein the data associated with the seal includes data indicative of an identification number of the seal.

25. The circuit of claim 20, wherein the data frame includes data associated with a shipment.

26. The circuit of claim 25, wherein the data associated with the shipment is selected from the group consisting of destination, consignee, load port, discharge port and vessel number.

27. The circuit of claim 20, wherein the data frame includes data associated with a container.
